(19) United States
(12) Patent Application Publication
(10) Pub. No.: US 2014/0347257 A1
(43) Pub. Date: Nov. 27, 2014

(54) METHOD OF DRIVING DISPLAY PANEL AND DISPLAY APPARATUS FOR PERFORMING THE SAME

(71) Applicant: Samsung Display Co., Ltd., Yongin-City (KR)

(72) Inventor: Masami IGAWA, Suwon-si (KR)

(73) Assignee: Samsung Display Co., Ltd., Yongin-City (KR)

(21) Appl. No.: 14/049,519

(22) Filed: Oct. 9, 2013

(30) Foreign Application Priority Data
May 22, 2013 (KR) 10-2013-0057777

(51) Int. Cl. G09G 3/36

(52) U.S. Cl. CPC G09G 3/3696
USPC 345/87

(57) ABSTRACT

A method of driving a display panel includes outputting a gate signal to a gate line of the display panel in response to a first control signal, and outputting a data voltage to a data line of the display panel in response to a second control signal using a plurality of driving chips, where driving timings of the driving chips are different from one another.

This application claims priority to Korean Patent Application No. 10-2013-0057777, filed on May 22, 2013, and all the benefits accruing therefrom under 35 U.S.C. §119, the content of which in its entirety is herein incorporated by reference.

### BACKGROUND

1. Field

Exemplary embodiments of the invention relate to a method of driving a display panel and a display apparatus for performing the method. More particularly, exemplary embodiments of the invention relate to a method of driving a display panel with improved driving reliability and with decreased bezel width, and a display apparatus for performing the method.

2. Description of the Related Art

Generally, a liquid crystal display (“LCD”) apparatus includes a first substrate including a pixel electrode, a second substrate including a common electrode and a liquid crystal layer disposed between the first and second substrate. An electric field is generated by voltages applied to the pixel electrode and the common electrode. By adjusting an intensity of the electric field, a transmittance of a light passing through the liquid crystal layer may be adjusted so that a desired image may be displayed.

Generally, a display apparatus includes a display panel and a panel driver. The display panel includes a plurality of gate lines and a plurality of data lines. The panel driver includes a gate driver that provides gate signals to the gate lines and a data driver that provides data voltages to the data lines.

To decrease the width of the bezel, a chip on glass (“COG”) method has been employed in the display apparatus. In the COG method, a portion of the panel driver or an entire panel driver is mounted on a substrate of the display panel. As a resolution of the display panel increases, a level of an output current of the data driver increases, but a positive power voltage of a logic voltage of the data driver tends to decrease.

Accordingly, when the data voltage is outputted from the data driver, a negative power voltage may momentarily increase, and if widths of wirings are increased to effectively prevent momentary increase of the negative power voltage when the data voltage is outputted, the width of the bezel may thereby increase.

### SUMMARY

Exemplary embodiments of the invention provide a method of driving a display panel, in which driving reliability is substantially improved a width of a bezel is substantially reduced.

Exemplary embodiments of the invention also provide a display apparatus that performs the method of driving the display panel.

In an exemplary embodiment of a method of driving a display panel according to the invention, the method includes outputting a gate signal to a gate line of the display panel in response to a first control signal, and outputting a data voltage to a data line of the display panel in response to a second control signal using a plurality of driving chips, where driving timings of the driving chips are different from one another.

In an exemplary embodiment, when a resistance of a portion of a signal wiring which transmits a power voltage to a driving chip of the driving chips is higher than a resistance of a portion of the signal wiring which transmits the power voltage to another driving chip of the driving chips, a driving timing of the driving chip is earlier than a driving timing of the another driving chip.

In an exemplary embodiment, the signal wiring may be sequentially connected to a first driving chip of the driving chips, a second driving chip of the driving chips, which is adjacent to the first driving chip, a third driving chip of the driving chips, which is adjacent to the second driving chip, and a fourth driving chip of the driving chips, which is adjacent to the third driving chip.

In an exemplary embodiment, the fourth driving chip, the third driving chip, the second driving chip and the first driving chip may sequentially output the data voltage.

In an exemplary embodiment, the signal wiring may include a first portion connected to a first driving chip of the driving chips, a second portion connected to a second driving chip of the driving chips, a third portion connected to a third driving chip of the driving chips, and a fourth portion connected to a fourth driving chip of the driving chips.

In an exemplary embodiment, the first and fourth driving chips may be disposed at an edge portion of the display panel, the second and third driving chips may be disposed at a central portion of the display panel, and the first and fourth driving chips may output the data voltage earlier than the second and third driving chips.

In an exemplary embodiment, the driving chips may control the driving timings thereof to be different from one another.

In an exemplary embodiment, the method may further include generating a plurality of driving chip control signals which controls the driving timings of the driving chips to be different from one another.

In an exemplary embodiment, when the driving timing of the driving chip is earlier than the driving timing of the another driving chip, a bias current of the driving chip is lower than a bias current of the another driving chip.

In an exemplary embodiment, the driving chips may be disposed on a substrate, on which the gate line and the data line are disposed.

In an exemplary embodiment of a display apparatus according to the invention, the display apparatus includes a display panel including a gate line and a data line and which displays an image, a timing controller which generates a first control signal and a second control signal, a gate driver which outputs a gate signal to the gate line in response to the first control signal, and a data driver which outputs a data voltage to the data line in response to the second control signal, where the data driver includes a plurality of driving chips disposed on a substrate, on which the gate line and the data line are disposed, and driving timings of the driving chips are different from one another.

In an exemplary embodiment, the data driver may further include a signal wiring disposed on the substrate and which transmits a power voltage to the driving chip and disposed on the substrate, and when a resistance of a portion of the signal wiring connected to a driving chip of the driving chips is higher than a resistance of a portion of the signal wiring connected to another driving chip of the driving chips, a driving timing of the driving chip is earlier a driving timing of the another driving chip.

In an exemplary embodiment, the driving chips of the data driver may include a first driving chip, a second driving chip adjacent to the first driving chip, a third driving chip adjacent to the second driving chip and a fourth driving chip adjacent to the third driving chip, and the signal wiring may be sequentially connected to the first driving chip, the second driving chip, the third driving chip and the fourth driving chip.

In an exemplary embodiment, the fourth driving chip, the third driving chip, the second driving chip and the first driving chip may sequentially output the data voltage.

In an exemplary embodiment, the driving chips of the data driver may include a first driving chip, a second driving chip adjacent to the first driving chip, a third driving chip adjacent to the second driving chip and a fourth driving chip adjacent to the third driving chip, and the signal wiring of the data driver may include a first portion connected to the first driving chip, a second portion connected to the second driving chip, a third portion connected to the third driving chip and a fourth portion connected to the fourth driving chip.

In an exemplary embodiment, the first and fourth driving chips are disposed at an edge portion of the display panel, the second and third driving chips are disposed at a central portion of the display panel, and the first and fourth driving chips output the data voltage earlier than the second and third driving chips.

In an exemplary embodiment, the driving chips may control the driving timings thereof to be different from one another.

In an exemplary embodiment, the timing controller may generate driving chip control signals, and outputs the driving chips control signals to the data driver, where the driving chips control signals control the driving timings of the driving chips to be different from one another.

In an exemplary embodiment, when the driving timing of the driving chip is earlier than the driving timing of the another driving chip, a bias current of the driving chip is lower than a bias current of the another driving chip.

According to embodiments of the method of driving the display panel and the display apparatus for performing the method, an output timing of a driving chip of a data driver is adjusted such that an increase of a negative power source in the data driver is effectively prevented. Thus, a driving reliability of the display apparatus is substantially improved.

In such embodiments, the negative power source in the data driver does not momentarily increase such that the display apparatus may include a thin and long wiring, and the width of the bezel of the display apparatus is thereby decreased.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus according to the invention;

FIG. 2 is a block diagram illustrating an exemplary embodiment of a data driver of FIG. 1;

FIG. 3 is a circuit diagram illustrating an exemplary embodiment of a level shifter of FIG. 2;

FIG. 4 is a plan view of an exemplary embodiment of a driving chip and a wiring of the data driver of FIG. 1;

FIG. 5 is a waveform diagram illustrating an exemplary embodiment of signals in the data driver of FIG. 1;

FIG. 6 is a plan view of an alternative exemplary embodiment of a driving chip and a wiring of a data driver according to the invention; and

FIG. 7 is a waveform diagram illustrating an exemplary embodiment of signals in the data driver of FIG. 6.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

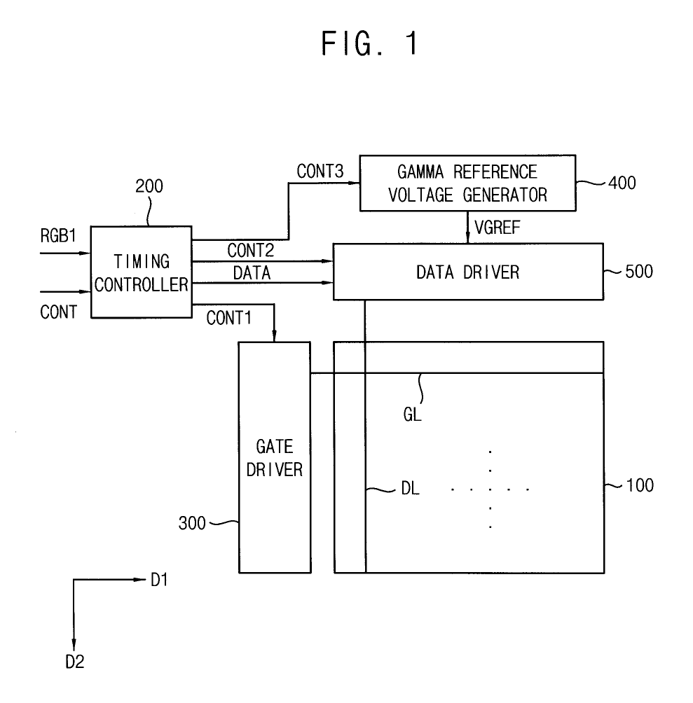

FIG. 1 is a block diagram illustrating an exemplary embodiment of a display apparatus according to the invention.

Referring to FIG. 1, an exemplary embodiment of the display apparatus includes a display panel 100 and a panel driver. The panel driver includes a timing controller 200, a gate driver 300, a gamma reference voltage generator 400 and a data driver 500.

The display panel 100 displays an image. The display panel 100 has a display region, on which an image is displayed, and a peripheral region adjacent to the display region.

The display panel 100 includes a plurality of gate lines GL, a plurality of data lines DL and a plurality of unit pixels connected to the gate lines GL and the data lines DL. The gate lines GL extend substantially in a first direction D1, and the data lines DL extend substantially in a second direction D2 crossing the first direction D1.

Each unit pixel includes a switching element (not shown), a liquid crystal capacitor (not shown) and a storage capacitor (not shown). The liquid crystal capacitor and the storage capacitor are electrically connected to the switching element. The unit pixels may be disposed substantially in a matrix form on the display region of the display panel 100.

The timing controller 200 receives input image data RGB1 and an input control signal CONT from an external apparatus (not shown). The input image data RGB1 may include red image data, green image data and blue image data. The input control signal CONT may include a master clock signal and a data enable signal. The input control signal CONT may further include a vertical synchronizing signal and a horizontal synchronizing signal.

The timing controller 200 generates a first control signal CONT1, a second control signal CONT2, a third control signal CONT3 and a data signal DATA based on the input image data RGB1 and the input control signal CONT.

The timing controller 200 generates the first control signal CONT 1 for controlling an operation of the gate driver 300 based on the input control signal CONT, and outputs the first control signal CONT1 to the gate driver 300. The first control signal CONT1 may further include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates the data signal DATA based on the input image data RGB1. The timing controller 200 outputs the data signal DATA to the data driver 500.

The timing controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals that drive the gate lines GL in response to the first control signal CONT1 received from the timing controller 200. The gate driver 300 sequentially outputs the gate signals to the gate lines GL.

The gate driver 300 may be directly disposed, e.g., mounted, on the display panel 100. In an alternative exemplary embodiment, or may be connected to the display panel 100 in the form of a tape carrier package (“TCP”). In another alternative exemplary embodiment, the gate driver 300 may be integrated on the peripheral region of the display panel 100.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value (e.g., a voltage level) corresponding to a level of the data signal DATA.

In an exemplary embodiment, the gamma reference voltage generator 400 may be disposed in the timing controller 200. In an alternative exemplary embodiment, the gamma reference voltage generator 400 may be disposed in the data driver 500.

The data driver 500 receives the second control signal CONT2 and the data signal DATA from the timing controller 200, and receives the gamma reference voltages VGREF from the gamma reference voltage generator 400. The data driver 500 converts the data signal DATA into data voltages of analog type using the gamma reference voltages VGREF. The data driver 500 outputs the data voltages to the data lines DL.

In an exemplary embodiment, the data driver 500 includes a plurality of driving chips. The driving chips are disposed, e.g., mounted, on the display panel 100. In one exemplary embodiment, for example, the driving chips may be disposed, e.g., mounted, on a substrate, on which the gate line GL and the data line DL are disposed.

In an alternative exemplary embodiment, the data driver 500 may be directly mounted on the display panel 100, or be connected to the display panel 100 in a TCP type. In another alternative exemplary embodiment, the data driver 500 may be integrated on the peripheral region of the display panel 100.

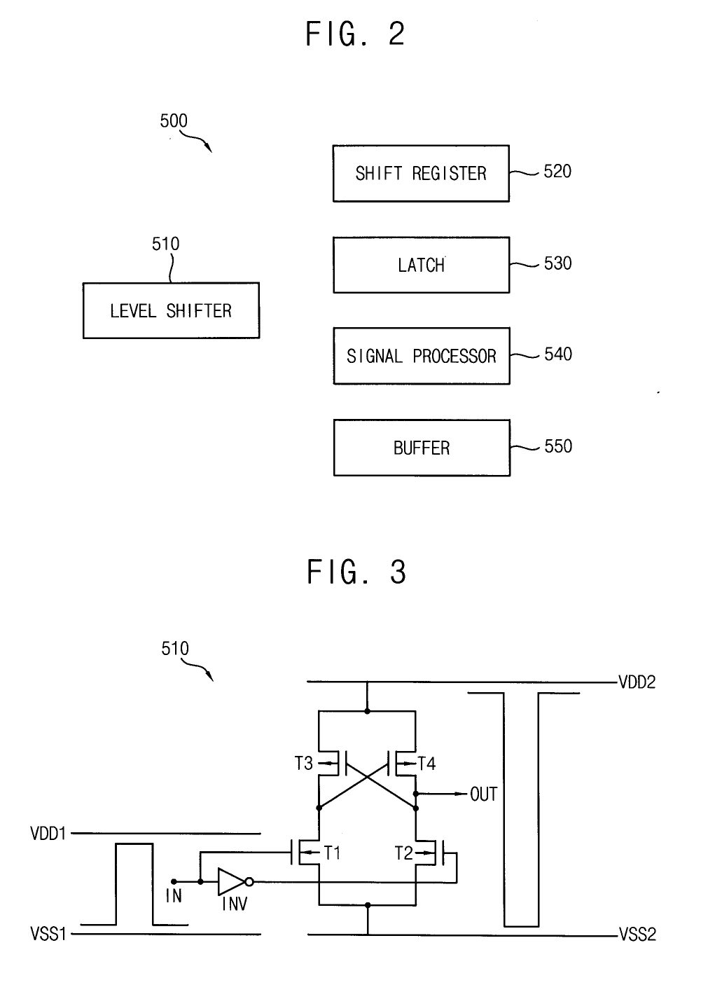

FIG. 2 is a block diagram illustrating an exemplary embodiment of the data driver 500 of FIG. 1. FIG. 3 is a circuit diagram illustrating an exemplary embodiment of a level shifter of FIG. 2.

Referring to FIGS. 1 to 3, the data driver 500 may include a level shifter 510, a shift register 520, a latch 530, a signal processor 540 and a buffer 550.

The level shifter 510 increases a level of an input voltage inputted to an input terminal IN to generate an output voltage. The level shifter 510 outputs the output voltage through an output terminal OUT.

In one exemplary embodiment, for example, the input voltage has a voltage level between a first positive power voltage VDD1 and a first negative power voltage VSS1. The output voltage has a voltage level between a second positive power voltage VDD2 higher than the first positive power voltage VDD1 and a second negative power voltage VSS2.

In an exemplary embodiment, the first positive power voltage VDD1 and the first negative power voltage VSS1 may be used in a digital operation. In such an embodiment, the first positive power voltage VDD1 may be referred to as a logic power, and the first negative power voltage VSS1 may be referred to as a logic ground. The second positive power voltage VDD2 and the second negative power voltage VSS2 may be transmitted to the shift register 520 and an analog output buffer 550. In one exemplary embodiment, for example, the first positive power voltage may have a voltage level between about 1 volt (V) and about 2 volts (V). In one exemplary embodiment, for example, the second positive power voltage may have a voltage level between about 7 V and about 10 V. In one exemplary embodiment, for example, the first negative power voltage VSS1 may be a ground voltage. In one exemplary embodiment, for example, the second negative power voltage VSS2 may be a ground voltage.

In one exemplary embodiment, for example, a waveform of the output voltage may be inverted from the input voltage. In one exemplary embodiment, for example, when the input voltage has a low level, the output voltage may have a high level. In one exemplary embodiment, for example, when the input voltage has a high level, the output voltage may have a low level.

The level shifter 510 includes an inverter INV and first to fourth switching elements T1, T2, T3 and T4. A first end portion of the inverter NV is connected to the input terminal IN of the level shifter 510 and a control electrode of the first switching element T1. A second end portion of the inverter NV is connected to a control electrode of the second switching element T2. An input electrode of the first switching element T1 is connected to a control electrode of the fourth switching element T4. The second negative power voltage VSS2 is applied to an output electrode of the first switching element T1. An input electrode of the second switching element T2 is connected to a control electrode of the third switching element T3. The second negative power voltage VSS2 is applied to an output electrode of the second switching element T2. The second positive power voltage VDD2 is applied to an input electrode of the third switching element T3. An output electrode of the third switching element T3 is connected to the input electrode of the first switching element T1. The second positive power voltage VDD2 is applied to an input electrode of the fourth switching element T4. An output electrode of the fourth switching element T4 is connected to the input electrode of the second switching element T2. The output terminal OUT of the level shifter 510 is connected to the output electrode of the fourth switching element T4.

In such an embodiment, the shift register 520 may include a plurality of process registers of a linear type in a digital circuit. The shift register 520 outputs a latch pulse to the latch 530.

The latch 530 temporarily stores the data signal DATA and outputs the data signal DATA to the signal processor 540.

The signal processor 540 converts the data signal DATA of digital type to a data voltage of analog type based on the gamma reference voltage VGREF, and outputs the data voltage. The signal processor 540 may include a digital-to-analog converter.

The buffer 550 buffers the data voltage outputted from the signal processor 540 and outputs the data voltage to the data line DL. The buffer 550 may include an amplifier connected to the data line DL.

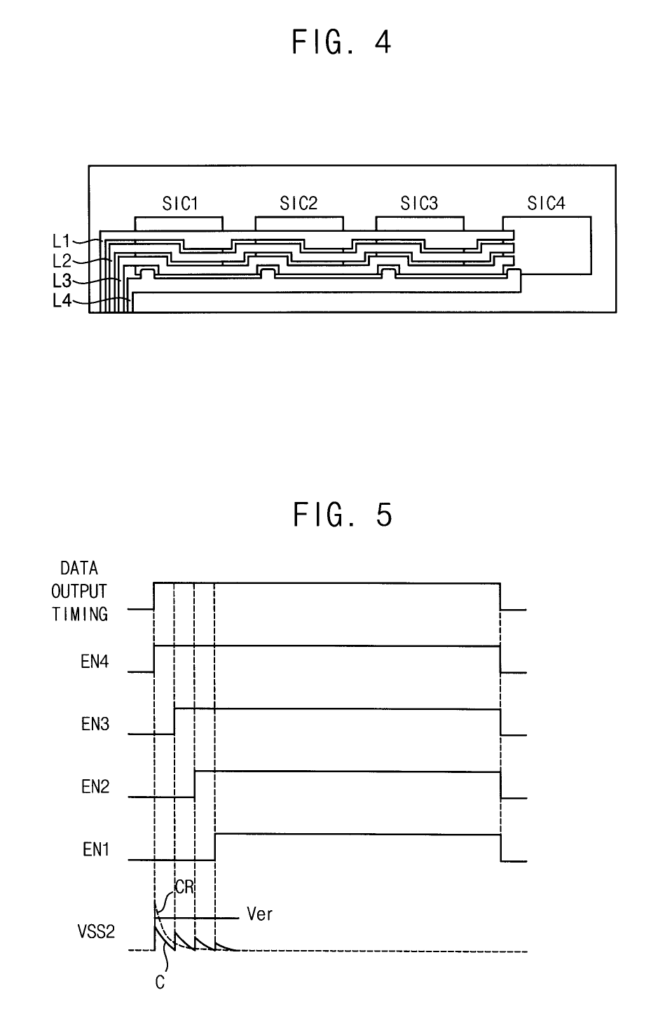

FIG. 4 is a plan view of an exemplary embodiment of a driving chip and a wiring of the data driver 500 of FIG. 1. FIG. 5 is a waveform diagram illustrating an exemplary embodiment of signals in the data driver 500 of FIG. 1.

Referring to FIGS. 1 to 5, the data driver 500 includes a plurality of driving chips. In one exemplary embodiment, for example, the data driver may include four driving chips SIC1, SIC2, SIC3 and SIC4. The data driver 500 includes a first driving chip SIC1, a second driving chip SIC2 adjacent to the first driving chip SIC1, a third driving chip SIC3 adjacent to the second driving chip SIC2 and a fourth driving chip SIC4 adjacent to the third driving chip SIC3.

The data driver 500 includes a signal wiring, e.g., a first signal wiring L1, a second wiring L2, a third signal wiring L3 and a fourth signal wiring L4, which transmits a power voltage to the driving chip SIC1, SIC2, SIC3 and SIC4. In an exemplary embodiment, each of the signal wiring L1, L2, L3 and L4 may be sequentially connected to the first driving chip SIC1, the second driving chip SIC2, the third driving chip SIC3 and the fourth driving chip SIC4. In such an embodiment, each of the signal wiring L1, L2, L3 and L4 may include a first portion connected to the first driving chip SIC1, a second portion connected to the second driving chip SIC2, a third portion connected to the third driving chip SIC3 and a fourth portion connected to the fourth driving chip SIC4.

In one exemplary embodiment, for example, the first signal wiring L1 may transmit the second positive power voltage VDD2 to the first to fourth driving chips SIC1, SIC2, SIC3 and SIC4. A second signal wiring L2 may transmit the first positive power voltage VDD1 to the first to fourth driving chips SIC1, SIC2, SIC3 and SIC4. A third signal wiring L3 may transmit the first negative power voltage VSS1 to the first to fourth driving chips SIC1, SIC2, SIC3 and SIC4. A fourth signal wiring L4 may transmit the second negative power voltage VSS2 to the first to fourth driving chips SIC1, SIC2, SIC3 and SIC4.

In an exemplary embodiment, the first driving chip SIC1 is relatively close to a power providing part (not shown), and the fourth driving chip SIC4 is relatively far from the power providing part (not shown). Thus, in such an embodiment, a resistance of a portion of a signal wiring connected to the fourth driving chip SIC4 is higher than a resistance of a portion of the signal wiring connected to the first driving chip SIC1.

In FIG. 5, EN1, which is an enable signal of the first driving chip SIC1, shows a driving timing of the first driving chip SIC1 for outputting the data voltage. EN2, which is an enable signal of the second driving chip SIC2, shows a driving timing of the second driving chip SIC2 for outputting the data voltage. EN3, which is an enable signal of the third driving chip SIC3, shows a driving timing of the third driving chip SIC3 for outputting the data voltage. EN4, which is an enable signal of the fourth driving chip SIC4, shows a driving timing of the fourth driving chip SIC4 for outputting the data voltage.

In an exemplary embodiment, when a resistance of a portion of the signal wiring (e.g. the first signal wiring L1) that transmits the power voltage to a driving chip of the driving chips SIC1, SIC2, SIC3 and SIC4 is relatively high, a driving timing of the driving chip of the driving chips SIC1, SIC2, SIC3 and SIC4 is set to be relatively early. In such an embodiment, when the resistance of a portion of the signal wiring (e.g. the first signal wiring L1) that transmits the power voltage to a driving chip (e.g., a fourth driving chip SIC4) is high than a resistance of a portion of the signal wiring (e.g., the first signal wiring) that transmits the power voltage to another driving chip (e.g., the first driving chip SIC1), the driving timing of the driving chip (e.g., the fourth driving chip SIC4) is set to be earlier than the driving timing of the another driving chip (e.g., the first driving chip SIC1). In one exemplary embodiment, for example, the fourth driving chip SIC4, the third driving chip SIC3, the second driving chip SIC2 and the first driving chip SIC1 sequentially output the data voltage.

CR curve in FIG. 5 shows a waveform of the second negative power voltage VSS2 of the fourth driving chip SIC4 in a display device using a conventional driving method, in which the driving chips concurrently output the data voltage. In the conventional driving method, the first to fourth driving chips SIC1 to SIC4 concurrently output the data voltage such that a noise may occur due to a resistance of the signal wiring, and thus, the second negative power voltage VSS2 of the fourth driving chip SIC4 momentarily increases. The fourth driving chip SIC4 is the farthest from the power providing part such that a resistance of a portion of the signal wiring connected to the fourth driving chip SIC4 is the highest, and the second negative power voltage VSS2 of the fourth driving chip SIC4 thereby increases the most.

Ver denotes an error reference voltage of abnormal operation of the level shifter 510 and the shift register 520 due to the increased second negative power voltage VSS2. When the second negative power voltage VSS2 exceeds the error reference voltage Ver, the level shifter 510 and the shift register 520 may operate abnormally.

Referring again to FIG. 3, when the second negative power voltage VSS2 exceeds the error reference voltage Ver, the level of the second power voltage VSS2 connected to the output electrodes of the first and second switching elements T1 and T2, the first and second switching elements T1 and T2 may not be normally turned on. Thus, the level shifter 510 abnormally operates and the shift register 520 and the buffer 550 may abnormally operate.

In an exemplary embodiment, the first to fourth driving chips SIC1, SIC2, SIC3 and SIC4 are controlled to have driving timings different from one another, e.g., to operate based on driving timings different from one another. C curve shows a waveform of the second negative power voltage VSS2 of the driving chips SIC1, SIC2, SIC3 and SIC4 in an exemplary embodiment.

In one exemplary embodiment, for example, a first rising waveform of C curve is a waveform of the second negative power voltage VSS2 of the fourth driving chip SIC4 when the fourth driving chip SIC4 outputs the data voltage. A second rising waveform of C curve is a waveform of the second negative power voltage VSS2 of the third driving chip SIC3 when the third driving chip SIC3 outputs the data voltage. A third rising waveform of C curve is a waveform of the second negative power voltage VSS2 of the second driving chip SIC2 when the second driving chip SIC2 outputs the data voltage. A fourth rising waveform of C curve is a waveform of the second negative power voltage VSS2 of the first driving chip SIC1 when the first driving chip SIC1 outputs the data voltage.

In an exemplary embodiment, as shown in FIG. 5, driving timings of the first to fourth driving chips SIC1, SIC2, SIC3 and SIC4 are set to be different from one another such that the second negative power voltage VSS2 is effectively prevented from exceeding the error reference voltage Ver, and the level shifter 510 and the shift register 520 thereby normally operate.

In an exemplary embodiment, the driving chips SIC1, SIC2, SIC3 and SIC4 may control the driving timings thereof to be different from one another. In one exemplary embodiment, for example, the driving chips SIC1, SIC2, SIC3 and SIC4 may store addresses thereof. In such an embodiment, the driving chips SIC1, SIC2, SIC3 and SIC4 may set the driving timings of the driving chips SIC1, SIC2, SIC3 and SIC4 based on the addresses thereof. In such an embodiment, the driving chips SIC1, SIC2, SIC3 and SIC4 may receive a driving chip control signal from the timing controller 200. In such an embodiment, the driving chips SIC1, SIC2, SIC3 and SIC4 generates the first to fourth driving enable signals EN1, EN2, EN3 and EN4 based on the driving chip control signal.

In an alternative exemplary embodiment, the timing controller 200 may generate a plurality of driving chip control signals and outputs the driving chip control signals to the data driver 500 such that the driving chips SIC1, SIC2, SIC3 and SIC4 have different driving timings. In such an embodiment, the timing controller may output the driving chip control signals having timings different from one another to the driving chips SIC1, SIC2, SIC3 and SIC4.

In an exemplary embodiment, when the driving timing of a driving chip of the driving chips SIC1, SIC2, SIC3 and SIC4 is relatively late, a bias current of the driving chip may be relatively high. In such an embodiment, when the driving timing of a driving chip of the driving chips SIC1, SIC2, SIC3 and SIC4 is earlier than the driving timing of another driving chip of the driving chips SIC1, SIC2, SIC3 and SIC4, a bias current of the driving chip of the driving chips SIC1, SIC2, SIC3 and SIC4 may be set or controlled to be lower than a bios current of the another driving chip of the driving chips SIC1, SIC2, SIC3 and SIC4. When the driving timing of the driving chip is relatively late, a charging time of a pixel connected to the driving chip may be relatively short. In such an embodiment, the bias current of the driving chip having a relatively short charging time increases such that a driving ability of the driving chip may be substantially improved, and decreased charging time of the driving chip may be effectively compensated.

In one exemplary embodiment, for example, a bias current of a buffer of the first driving chip SIC1 may be the highest, and a bias current of a buffer of the fourth driving chip SIC4 may be the lowest.

In FIGS. 4 and 5, an exemplary embodiment where the data driver 500 including four driving chips is shown, but the invention is not limited thereto. In an alternative exemplary embodiment, the data driver 500 may include N driving chips. Here, N is a positive integer.

According to an exemplary embodiment, driving timings of the driving chips SIC1, SIC2, SIC3 and SIC4 are set to be different from one another such that the second negative power voltage VSS2 in the signal wiring is effectively prevented from exceeding the error reference voltage Ver, and a driving reliability is thereby substantially improved.

In such an embodiment, driving timings of the driving chips SIC1, SIC2, SIC3 and SIC4 are set to be different from one another, such that the second negative power voltage VSS2 in the signal wiring does not momentarily increase such that the signal wiring may have a relatively high resistance. Accordingly, in such an embodiment, a thin and long signal wiring may be employed, such that a width of a bezel of the display apparatus may decrease.

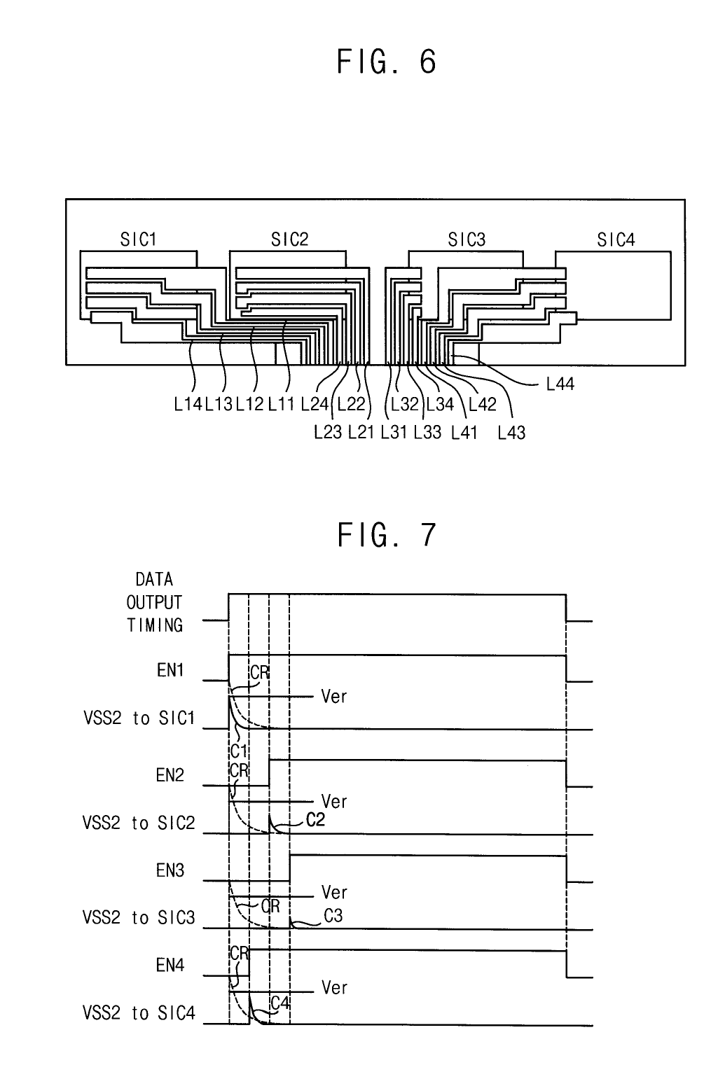

FIG. 6 is a plan view of an alternative exemplary embodiment of a driving chip and a wiring of a data driver according to the invention. FIG. 7 is a waveform diagram illustrating an exemplary embodiment of signals in the data driver of FIG. 6.

The exemplary embodiment of the method of driving the display panel and the exemplary embodiment of the display apparatus for performing the method shown in FIGS. 6 and 7 are substantially the same as the exemplary embodiment of the method of driving the display panel and the exemplary embodiment of the display apparatus for performing the method shown in FIGS. 1 to 5 except for a wiring structure connecting the driving chips. The same or like elements shown in FIGS. 6 and 7 have been labeled with the same reference characters as used above to describe the exemplary embodiments shown in FIGS. 1 to 5, and any repetitive detailed description thereof may be omitted or simplified.

Referring to FIGS. 1 to 3, 6 and 7, an exemplary embodiment of the display apparatus includes a display panel 100 and a panel driver. The panel driver includes a timing controller 200, a gate driver 300, a gamma reference voltage generator 400 and a data driver 500.

The display panel 100 displays an image. The display panel 100 includes a plurality of gate lines GL, a plurality of data lines DL and a plurality of unit pixels connected to the gate lines GL and the data lines DL.

The timing controller 200 generates a first control signal CONT1, a second control signal CONT2, a third control signal CONT3 and a data signal DATA based on an input image data RGB1 and an input control signal CONT.

The gate driver 300 generates gate signals for driving the gate lines GL in response to the first control signal CONT 1 received from the timing controller 200. The gate driver 300 sequentially outputs the gate signals to the gate lines GL.

The gamma reference voltage generator 400 generates a gamma reference voltage VGREF in response to the third control signal CONT3 received from the timing controller 200.

The data driver 500 converts the data signal DATA into data voltages of analog type using the gamma reference voltages VGREF. The data driver 500 outputs the data voltages to the data lines DL.

The data driver 500 includes a plurality of driving chips. In one exemplary embodiment, for example, the data driver may include four driving chips SIC1, SIC2, SIC3 and SIC4. In such an embodiment, the data driver 500 includes a first driving chip SIC1, a second driving chip SIC2 adjacent to the first driving chip SIC1, a third driving chip SIC3 adjacent to the second driving chip SIC2 and a fourth driving chip SIC4 adjacent to the third driving chip SIC3.

The data driver 500 includes a plurality of signal wirings L11 to L44 for transmitting a power voltage to the driving chips SIC1, SIC2, SIC3 and SIC4. In such an embodiment, the signal wirings L11 to L44 includes a first signal wiring L11, L21, L31 and L41, a second signal wiring L12, L22, L32 and L42, a third signal wiring L13, L23, L33 and L43, and a fourth signal wiring L14, L24, L34 and L44. In an exemplary embodiment, each of the first to fourth wirings includes a first portion L11 to L14 connected to the first driving chip SIC1, a second portion L21 to L24 connected to the second driving chip SIC2, a third portion L31 to L34 connected to the third driving chip SIC3, and a fourth portion L41 to L44 connected to the fourth driving chip SIC4, where the first to fourth portions are separated or spaced apart from each other.

In one exemplary embodiment, for example, the first signal wiring L11, L21, L31 and L41 may transmit a second positive power voltage VDD2 to the first to fourth driving chips SIC1, SIC2, SIC3 and SIC4. The second signal wiring L12, L22, L32 and L42 may transmit the first positive power voltage VDD1 to the first to fourth driving chips SIC1, SIC2, SIC3 and SIC4. The third signal wiring L13, L23, L33 and L43 may transmit the first negative power voltage VSS1 to the first to fourth driving chips SIC1, SIC2, SIC3 and SIC4. The fourth signal wiring L14, L24, L34 and L44 may transmit the second negative power voltage VSS2 to the first to fourth driving chips SIC1, SIC2, SIC3 and SIC4.

The first driving chip SIC1 and the fourth driving chip disposed substantially close to an edge portion of the display panel 100 are relatively far from a power providing part (not shown). The second driving chip SIC2 and the third driving chip disposed in a central portion of the display panel 100 are relatively close to the power providing part (not shown). Thus, in such an embodiment, resistances of portions of the signal wirings connected to the first and fourth driving chips SIC1 and SIC4 are higher than resistances of portions of the signal wirings connected to the second and third driving chips SIC2 and SIC3. In one exemplary embodiment, for example, the signal wirings may extend to a left portion of the driving chips SIC1, SIC2, SIC3 and SIC4. In such an embodiment, a resistance of a portion of the signal wiring connected to the first driving chip SIC1 is higher than a resistance of a portion of the signal wiring connected to the fourth driving chip SIC4, and a resistance of a portion of the signal wiring connected to the second driving chip SIC2 is higher than a resistance of a portion of the signal wiring connected to the third driving chip SIC3.

In FIG. 7, EN1, which is an enable signal of the first driving chip SIC1, shows a driving timing of the first driving chip SIC1 for outputting the data voltage. EN2, which is an enable signal of the second driving chip SIC2, shows a driving timing of the second driving chip SIC2 for outputting the data voltage. EN3, which is an enable signal of the third driving chip SIC3, shows a driving timing of the third driving chip SIC3 for outputting the data voltage. EN4, which is an enable signal of the fourth driving chip SIC4, shows a driving timing of the fourth driving chip SIC4 for outputting the data voltage.

In an exemplary embodiment, when a resistance of a portion of the signal wiring that transmits the power voltage to the driving chip SIC1, SIC2, SIC3 and SIC4 is relatively high (e.g., higher than a resistance of a portion of the signal wiring that transmits the power voltage to another driving chip), a driving timing of the driving chip SIC1, SIC2, SIC3 and SIC4 is relatively early (e.g., earlier than a driving timing of the another driving chip). In one exemplary embodiment, for example, the first driving chip SIC1, the fourth driving chip SIC4, the second driving chip SIC2 and the third driving chip SIC3 sequentially output the data voltage.

In an alternative exemplary embodiment, the first driving chip SIC1 and the fourth driving chip SIC4 output the data voltage in a first timing, and the second driving chip SIC2 and the third driving chip SIC3 output the data voltage in a second timing, which is later than the first timing.

CR curve in FIG. 7 shows a waveform of the second negative power voltage VSS2 of the fourth driving chip SIC4 in a conventional driving method in which the driving chips concurrently output the data voltage. In the conventional driving method, the first to fourth driving chips SIC1 to SIC4 concurrently output the data voltage such that a noise may occur due to a resistance of the signal wiring.

Referring again to FIG. 3, when the second negative power voltage VSS2 exceeds an error reference voltage Ver, the level of the second power voltage VSS2 connected to the output electrodes of the first and second switching elements T1 and T2, the first and second switching elements T1 and T2 may not be normally turned on. Thus, the level shifter 510 abnormally operates, and the shift register 520 and the buffer 550 may abnormally operate.

In an exemplary embodiment, the first to fourth driving chips SIC1, SIC2, SIC3 and SIC4 are controlled to have driving timings different from one another. C1 curve in FIG. 7 shows a waveform of the second negative power voltage VSS2 of the first driving chip SIC1 when the first driving chip SIC1 outputs the data voltage. C2 curve in FIG. 7 shows a waveform of the second negative power voltage VSS2 of the second driving chip SIC2 when the second driving chip SIC2 outputs the data voltage. C3 curve in FIG. 7 shows a waveform of the second negative power voltage VSS2 of the third driving chip SIC3 when the third driving chip SIC3 outputs the data voltage. C4 curve in FIG. 7 shows a waveform of the second negative power voltage VSS2 of the fourth driving chip SIC4 when the fourth driving chip SIC4 outputs the data voltage.

As shown in FIG. 7, in an exemplary embodiment, the first to fourth driving chips SIC1, SIC2, SIC3 and SIC4 have driving timings different from one another such that the second negative power voltage VSS2 is effectively prevented from exceeding the error reference voltage Ver. Thus, in such an embodiment, the level shifter 510 and the shift register 520 normally operate.

In an exemplary embodiment, the driving chips SIC1, SIC2, SIC3 and SIC4 may control the driving timings thereof to be different from one another.

In an alternative exemplary embodiment, the timing controller 200 may generate a plurality of driving chip control signals and outputs the driving chip control signals to the data driver 500 such that the driving chips SIC1, SIC2, SIC3 and SIC4 have different driving timings.

In an exemplary embodiment, when the driving timing of the driving chip is relatively late, a bias current of the driving chip may be relatively high. In one exemplary embodiment, for example, a bias current of a buffer of the third driving chip SIC3 may be the highest, and a bias current of a buffer of the first driving chip SIC1 may be the lowest.

In FIGS. 6 and 7, an exemplary embodiment where the data driver 500 including four driving chips is shown, but the invention is not limited thereto. In an alternative exemplary embodiment, the data driver 500 may include N driving chips. Herein, N is a positive integer.

According to an exemplary embodiment, the driving chips SIC1, SIC2, SIC3 and SIC4 has driving timings different from one another such that the second negative power voltage VSS2 in the signal wiring is effectively prevented from exceeding the error reference voltage Ver, and a driving reliability is thereby substantially improved.

In such an embodiment, where the driving chips SIC1, SIC2, SIC3 and SIC4 has driving timings different from one another, the second negative power voltage VSS2 in the signal wiring does not momentarily increase such that a relatively high resistance of the signal wiring may be included in the display apparatus. In one exemplary embodiment, for example, the display apparatus includes a thin and long signal wiring such that a width of a bezel of the display apparatus may decrease.

According to exemplary embodiments of the invention, as described above, a display apparatus includes a data driver including a plurality of driving chips, driving timings of which are set to be different from one another such that a driving reliability of the display apparatus is substantially improved and the width of the bezel of the display apparatus may be substantially decreased.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel, the method comprising:
outputting a gate signal to a gate line of the display panel in response to a first control signal; and
outputting a data voltage to a data line of the display panel in response to a second control signal using a plurality of driving chips, wherein driving timings of the driving chips are different from one another.

2. The method of claim 1, wherein when a resistance of a portion of a signal wiring which transmits a power voltage to a driving chip of the driving chips is higher than a resistance of a portion of the signal wiring which transmits the power voltage to another driving chip of the driving chips, a driving timing of the driving chip is earlier than a driving timing of the another driving chip.

3. The method of claim 2, wherein
the signal wiring is sequentially connected to a first driving chip of the driving chips, a second driving chip of the driving chips, which is adjacent to the first driving chip, a third driving chip of the driving chips, which is adjacent to the second driving chip, and a fourth driving chip of the driving chips, which is adjacent to the third driving chip.

4. The method of claim 3, wherein the fourth driving chip, the third driving chip, the second driving chip and the first driving chip sequentially output the data voltage.

5. The method of claim 2, wherein the signal wiring comprises:
a first portion connected to a first driving chip of the driving chips;
a second portion connected to a second driving chip of the driving chips;
a third portion connected to a third driving chip of the driving chips; and
a fourth portion connected to a fourth driving chip of the driving chips.

6. The method of claim 5, wherein
the first and fourth driving chips are disposed at an edge portion of the display panel,
the second and third driving chips are disposed at a central portion of the display panel, and
the first and fourth driving chips output the data voltage earlier than the second and third driving chips.

7. The method of claim 2, wherein the driving chips controls the driving timings thereof to be different from one another.

8. The method of claim 2, further comprising:
generating a plurality of driving chip control signals which controls the driving timings of the driving chips to be different from one another.

9. The method of claim 2, wherein when the driving timing of the driving chip is earlier than the driving timing of the another driving chip, a bias current of the driving chip is lower than a bias current of the another driving chip.

10. The method of claim 1, wherein the driving chips are disposed on a substrate, on which the gate line and the data line are disposed.

11. A display apparatus comprising:
a display panel comprising a gate line and a data line and which displays an image;
a timing controller which generates a first control signal and a second control signal;
a gate driver which outputs a gate signal to the gate line in response to the first control signal; and
a data driver which outputs a data voltage to the data line in response to the second control signal,
wherein the data driver comprises a plurality of driving chips disposed on a substrate, on which the gate line and the data line are disposed, and
wherein driving timings of the driving chips are different from one another.

12. The display apparatus of claim 11, wherein
the data driver further comprises a signal wiring disposed on the substrate and which transmits a power voltage to the driving chips, and
when a resistance of a portion of the signal wiring connected to a driving chip of the driving chips is higher than a resistance of a portion of the signal wiring connected to another driving chip of the driving chips, a driving timing of the driving chip is earlier a driving timing of the another driving chip.

13. The display apparatus of claim 12, wherein
the driving chips of the data driver comprise a first driving chip, a second driving chip adjacent to the first driving chip, a third driving chip adjacent to the second driving chip and a fourth driving chip adjacent to the third driving chip, and
the signal wiring is sequentially connected to the first driving chip, the second driving chip, the third driving chip and the fourth driving chip.

14. The display apparatus of claim 13, wherein the fourth driving chip, the third driving chip, the second driving chip and the first driving chip sequentially output the data voltage.

15. The display apparatus of claim 12, wherein
the driving chips of the data driver comprise a first driving chip, a second driving chip adjacent to the first driving chip, a third driving chip adjacent to the second driving chip, and a fourth driving chip adjacent to the third driving chip, and
the signal wiring of the data driver comprises a first portion connected to the first driving chip, a second portion connected to the second driving chip, a third portion connected to the third driving chip and a fourth portion connected to the fourth driving chip.

16. The display apparatus of claim 15, wherein
the first and fourth driving chips are disposed at an edge portion of the display panel,
the second and third driving chips are disposed at a central portion of the display panel, and
the first and fourth driving chips output the data voltage earlier than the second and third driving chips.

17. The display apparatus of claim 12, wherein the driving chips control the driving timings thereof to be different from one another.

18. The display apparatus of claim 12, wherein
the timing controller generates a plurality of driving chip control signals, and outputs the driving chip control signals to the data driver, wherein the driving chip control signals control the driving timings of the driving chips to be different from one another.

19. The display apparatus of claim 12, wherein when the driving timing of the driving chip of the driving chips is earlier than the driving timing of the another driving chip, a bias current of the driving chip is lower than a bias current of the another driving chip.
